(19) United States
(12) Patent Application Publication
(10) Pub. No.: US 2010/0113202 A1
(43) Pub. Date: May 6, 2010

(54) Single motor clutchless CVT without torque converter

(75) Inventors: Benjamin A. Treichel, Peoria, IL (US); David M. Spurlock, Metamora, IL (US); Kevin G. Meyer, Metamora, IL (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: Caterpillar Inc., Peoria, IL (US)

(21) Appl. No.: 12/266,404

(22) Filed: Nov. 6, 2008

(51) Int. Cl. F16H 3/72

(52) U.S. Cl. 475/5

(57) ABSTRACT

A single motor clutchless, torque converter-less buffer system is provided for linking an engine (101) to a transmission (111). Within this context of this system, the drive train comprises an engine (101), an electric motor (103), and a lossless buffer (109)receiving the engine output (106) and the motor output (107), and having a buffer output (113), such that the lossless buffer (109) provides a range of transmission ratios including a zero transmission ratio. The term “lossless” denotes the absence of intentional frictional losses/slippage such as may be present in clutches and torque converters. In an embodiment, the lossless buffer (109) includes a planetary system between the engine (101) and the transmission (111), wherein the single electric motor (103) functions to vary the transmission ratio of the buffer (109).

### TECHNICAL FIELD

This patent disclosure relates generally to continuously variable transmissions and, more particularly to continuously variable transmission having a clutchless input that does not require a torque converter.

### BACKGROUND

When a powered machine is accelerated, i.e., “launched,” from a standstill to a forward or reverse speed, the primary mover, e.g., the engine, of the machine transitions from a disengaged state to an engaged state. Whenever the engine is in the engaged state, its speed is generally related to the speed of the machine by a transmission ratio. However, this relationship is approximate in that a clutch or torque converter is generally employed to smooth the transition from the disengaged to the engaged state. Without the clutch or torque converter, the engine could stall or, at best, lug severely.

Although a number of types of transmissions are usable in such machines, a continuously variable transmission (“CVT”) is often used for its ability to provide a wide range of ratios and to smoothly vary the transmission ratio. One traditional CVT type is a split path transmission which includes an input for the primary mover as well as for two motors. The two motors, working in cooperation, set the ratio of the transmission. However, while providing smooth operation and a wide range of transmission ratios, the motors also contribute size, weight, and expense to the final transmission assembly.

Although single motor CVTs have been attempted, none has been of a design and configuration sufficient to substantially ameliorate the foregoing problems.

### SUMMARY

In one aspect, the disclosed principles pertain to a single motor drive train system for propelling a host machine, the drive train system comprising an engine, a motor, and a lossless buffer receiving the engine output and the motor output, and having a buffer output, such that the lossless buffer provides a range of transmission ratios between the rotational engine output and the rotational buffer output, wherein the range of transmission ratios includes a zero transmission ratio. It should be noted that in the context of this disclosure, the term “lossless” does not mean that the entity in question experiences, or has imposed upon it, no loss of energy whatsoever. Rather, the term “lossless” denotes the absence of intentional frictional losses/slippage such as may be present in clutches and torque converters.

Continuing with this aspect of the disclosure, the transmission input is linked directly to the rotational buffer output, and has a rotational transmission output linked to a propulsion means to propel the host machine. Thus, rotation of the transmission input rotates the transmission output, causing the propulsion means to propel the host machine.

In another aspect, a machine is provided for rendering clutchless engagement of a transmission without the use of a torque converter. The machine comprises an engine for propelling the machine, a transmission having a transmission input and a transmission output, and a lossless buffer between the engine and the transmission, wherein the lossless buffer employs a single electric motor to provide ratios in a range including zero between the engine output and the transmission input.

In yet another aspect of the disclosure, a buffer system is provided for managing the transmission of power between an engine and a transmission in the absence of a torque converter or clutch between the engine and the transmission. The buffer system comprises a mechanical buffer receiving as input an output of the engine and providing as output an input to the transmission, and a single electric motor controlling the input-to-output transmission ratio of the mechanical buffer to allow the mechanical buffer to provide such ratios in a range including zero. The system also includes a controller for controlling the single electric motor to modify the transmission ratio of the mechanical buffer.

Other aspects and features will be apparent from the detailed description, taken in conjunction with the drawings, of which:

### BRIEF DESCRIPTION OF THE DRAWINGS

FIG. 1 is a schematic illustration showing a power train system and an associated environment within which embodiments of the disclosed principles may be employed;

FIG. 2 is a schematic illustration of a lossless buffer system according to an embodiment of the disclosed principles;

FIG. 3 is a power flow diagram illustrating power flow during an idle mode from an engine to a motor via a lossless buffer according to an embodiment of the disclosed principles;

FIG. 4 is a power flow diagram illustrating power flow from an engine and motor to machine propulsion via a lossless buffer during propelled motion of the host machine according to an embodiment of the disclosed principles;

FIG. 5 is a power flow diagram illustrating power flow from the host machine to the motor via the lossless buffer during braking of the host machine according to an embodiment of the disclosed principles; and

FIG. 6 is a flow chart illustrating a process of regulating and coordinating a lossless buffer, engine and motor according to an embodiment of the disclosed principles.

### DETAILED DESCRIPTION

This disclosure relates to machines requiring a transmission to link a power source to a final ground-engaging mechanism, e.g., wheels, tracts, etc. Examples of such machines include machines used for mining, construction, farming, transportation, and other industries and endeavors known in the art. For example, the machine may be an earth-moving machine, such as a wheel loader, excavator, dump truck, backhoe, motor grader, material handler or the like. Moreover, an implement may be connected to the machine. Such implements may be utilized for a variety of tasks, including, for example, loading, compacting, lifting, brushing, and may include, for example, buckets, compactors, forked lifting devices, brushes, grapples, cutters, shears, blades, breakers/hammers, augers, and others.

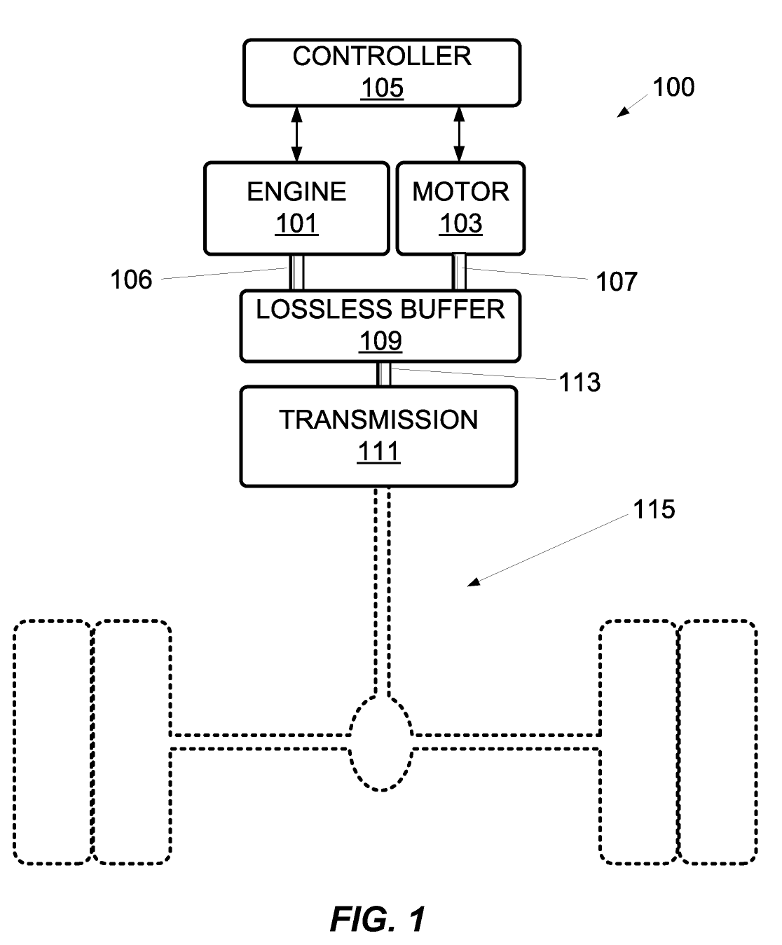

FIG. 1 is a diagrammatic illustration showing a power train system 100 and the associated environment within which embodiments of the disclosed principles may be used. The illustrated power train system 100 includes an engine 101, which is an example of a primary mover, having an engine output 106. It will be appreciated that the operation of the engine 101 is executed based on one or more inputs, including, for example, an input from a user interface (not shown), e.g., a pedal or lever, as well as an input from a controller 105, e.g., for purposes of torque control, traction control, etc.

A motor 103, e.g., an electric motor is provided having a motor output 107. It will be appreciated that the motor 103 may consume electrical energy to provide a torque or may be driven while providing a reactive force, thus generating electricity for storage in a battery (not shown) or other storage element. A lossless buffer 109 is interposed between the motor 103 and engine 101, and a transmission 111. For driving a load, the lossless buffer 109 provides at a buffer output 113 to the transmission 111 a weighted combination of the rotation of the engine 101 and the rotation of the motor 103.

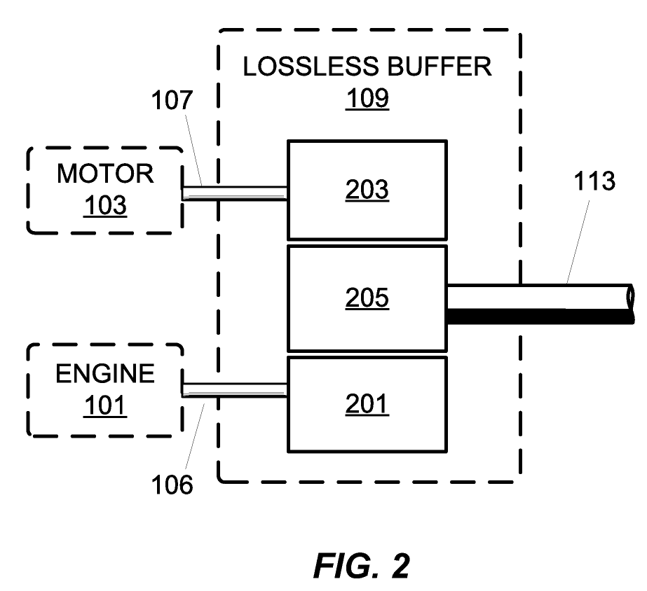

The details of the lossless buffer 109 will be discussed in detail below with reference to FIG. 2, however, before proceeding, the characteristics and operation of the power train system 100 will be described in overview via continued reference to FIG. 1. As can be seen, the power train system 100 operates to provide rotational power to the remainder of the machine drive train 115, which may comprise one or both of wheels, tracks, or other propulsion means. The power required to propel the drive train 115 originates in the primary mover, e.g., the engine 101. Additional power may be supplied via a battery which may be charged by one or both of an off-board system and the motor 103.

The power train system 100 exhibits three primary states. The first occurs when the engine 101 is running, but the machine is not moving. In this state, the torque provided to the transmission 111 by the engine 101 via the engine output 106 is essentially reflected to the motor 103 via the motor output 107, whereupon the energy is either stored, e.g., via a battery, or dissipated, e.g., via a resistive grid. In the second state, usually occurring when the machine is being launched from the first state, the engine 101 provides torque to the lossless buffer 109 via the engine output 106, the machine is moving at least slightly, and the motor 103 is being driven by the lossless buffer 109 via the motor output 107, but is providing a reactive torque to accelerate or move the machine.

In other words, in this second stage, the motor 103 resists movement, and as such, the buffer output 113 of the lossless buffer 109 moves or accelerates under the force of the engine 101. In the third stage, the engine 101 provides torque to the lossless buffer 109 via the engine output 106 and the motor 103 provides proactive torque to the lossless buffer 109 via the motor output 107. In this state, the rotational speed of the buffer output 113 is a weighted average of the rotational speed of the engine 101 and the motor 103. The effective transmission ratio of the lossless buffer 109 relative to the engine output 106 is controlled by the rotational speed of the motor output 107, i.e., the rotational speed of the motor 103. Thus, for example, if the engine speed and motor speed are of equal magnitudes but opposite directions, the transmission ratio of the lossless buffer 109 is zero. Moreover, fractional or overdrive ratios between the engine output 106 and the buffer output 113 can be provided by varying the speed of rotation of the motor output shaft 107.

The illustrated configuration thus allows the machine to be launched from a stationary state to a moving state without clutches or torque converters between the engine 101 and the split torque transmission 103, while also allowing a wide range of effective transmission ratios. This provides the benefits of allowing a compact and simple installation, while avoiding excess expenditures on equipment and maintenance.

FIG. 2 illustrates in detail an example of a lossless buffer 109 according to the disclosed principles. In particular, FIG. 2 is a schematic view of the lossless buffer 109, showing exemplary configurations and internal connections and gearings of the lossless buffer 109. As discussed above, the lossless buffer 109 links an engine output 106, a motor output 107, and a buffer output 113. In the illustrated embodiment, the lossless buffer 109 includes a planetary gear set 200 including at least one sun gear 201, at least one ring gear 203, and at least one planet gear/planet gear carrier assembly 205.

As can be seen, the engine output 106 is connected to the at least one sun gear 201, such that rotation of the engine 101 serves to rotate the at least one sun gear 201 at a like speed and in a like direction. Also shown, the motor output 107 is linked to the at least one ring gear 203. In this way, the torque of the at least one ring gear 203 is transferred to second input 107 and hence to the motor 103. Likewise, the torque of the motor 103 is transferred via the motor output 107 to the at least one ring gear 203. Finally, in the illustrated embodiment, the at least one planet gear/planet gear carrier assembly 205 is linked to the buffer output 113. In this way, the engine output 106, motor output 107, and buffer output 113 are interconnected and their rotational speeds are interrelated.

It will be appreciated that the tooth counts used to reach these ratios are not critical, and that the ratios used in any particular implementation need not match the example given above to fall within the disclosed principles of operation.

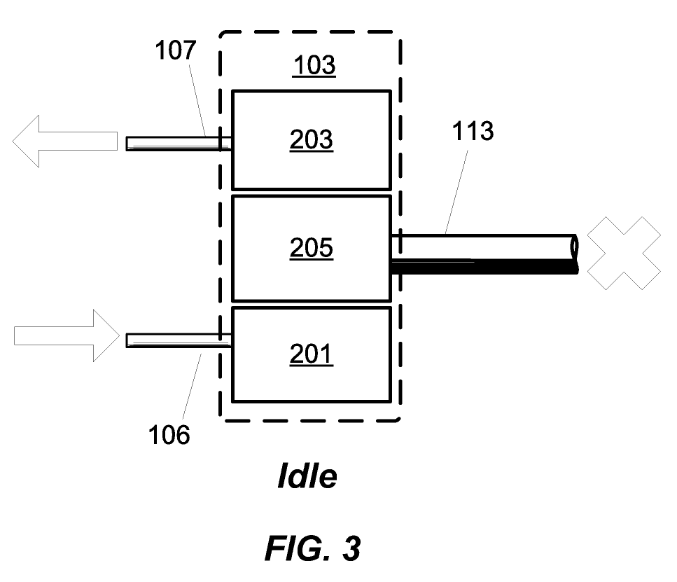

FIGS. 3-5 illustrate the power flow in the lossless buffer 109 according to the disclosed principles in various modes of operation including an idle state, a moving state, and a braking state. Referring specifically to FIG. 3, the power flow during the idle mode is from the engine 101 via the engine output 106 to the motor 103 via the motor output 107. In this mode, the buffer output 113 is static because the host machine is stationary.

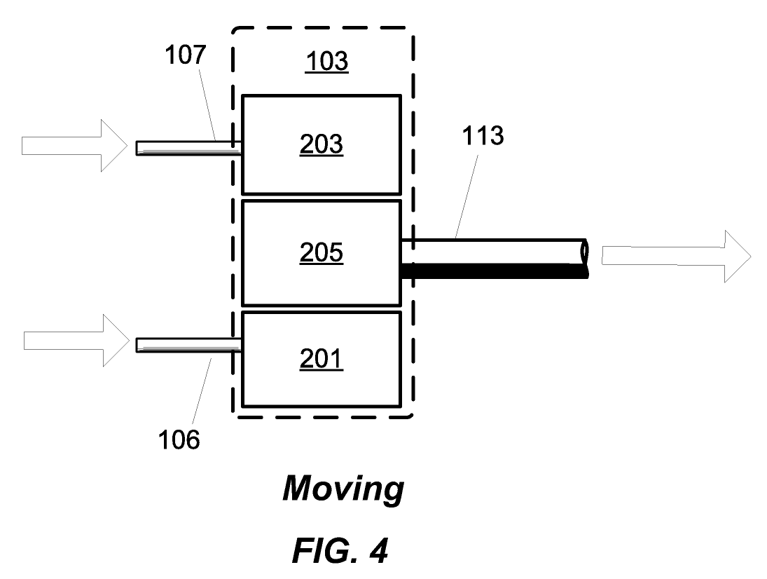

Referring to FIG. 4, this power flow diagram illustrates the power flow through the lossless buffer 109 during propelled motion of the host machine. As can be seen, the power flow in this instance is from the engine 101 via the engine output 106, and from the motor 103 via the motor output 107, to the buffer output 113. It will be appreciated that within this mode, the engine 101 provides a rotational torque in a given direction and the lossless buffer 109 imposes a rotational torque on the buffer output 113 in a given direction. However, the motor 103 may provide either active or reactive torque and thus will rotate in a direction that is dependent upon the desired speed of the machine in motion.

Thus, for example, at the time of transition from the idle mode to forward or reverse motion of the machine, the motor 103 transitions from being a strictly driven element to providing an active or reactive torque at the second input 107. The active or reactive torque can be generated by supplying a voltage input to the motor 103 in a direction the same as or opposite to (for reactive torque) the induced current, with the polarity of voltage determining the direction of the applied torque and the magnitude of the voltage determining the extent of the torque on the motor output 107.

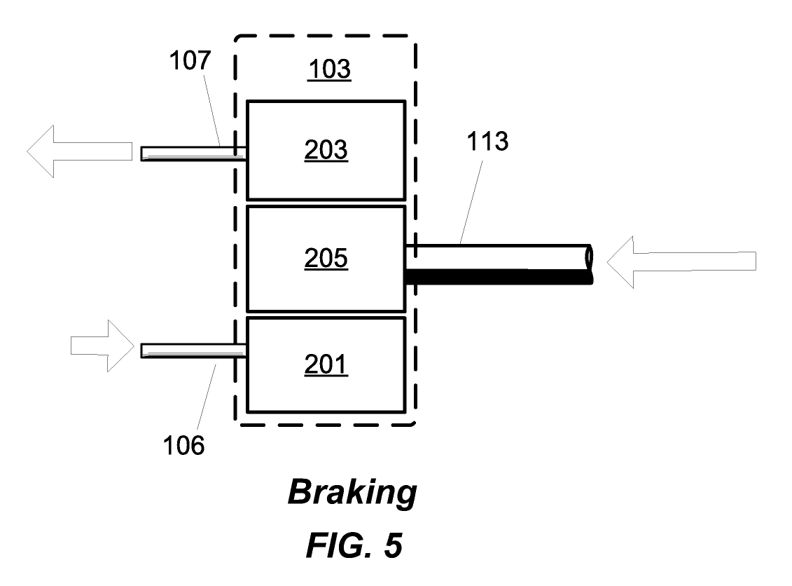

It is also expected to use the illustrated configuration to provide a braking force to the buffer output 113, e.g., to decelerate the host machine. FIG. 5 illustrates the power flow in the split torque transmission 103 during braking. In particular, the engine 101, which is no longer needed for acceleration, provides a resistive or reactive torque to the engine output 106. At the same time, the motor 103 is switched from a powering mode to a generating mode, such that any electrical power is dissipated, e.g., via a resistive grid, or stored, e.g., via one or more batteries. Ordinary service brakes, e.g., friction brakes, may also be employed at this time. Moreover, it will be appreciated that, depending upon the degree of braking required, powered reactive braking through the motor 103 may also be employed.

As shown in the example environment of FIG. 1, the operation of the lossless buffer 109 as well as the engine 101 and the motor 103 are monitored and controlled via a controller 105. The controller 105 may be any computing device capable of sensing one or more conditions of the lossless buffer 109, engine 101 and/or motor 103 and providing control outputs to one or more of the lossless buffer 109, engine 101 and motor 103. By way of example, the controller 105 may be integrated with an engine or machine control module, or may be a separate device. The controller 105 operates by reading computer-readable instructions from a computer-readable medium and executing the read instructions. The computer-readable medium may be a tangible medium such as a hard drive, optical disc, jump drive, thumb drive, flash memory, ROM, PROM, RAM, etc., or may be an intangible medium such as an electrical or optical wave form traveling in air, vacuum, or wire.

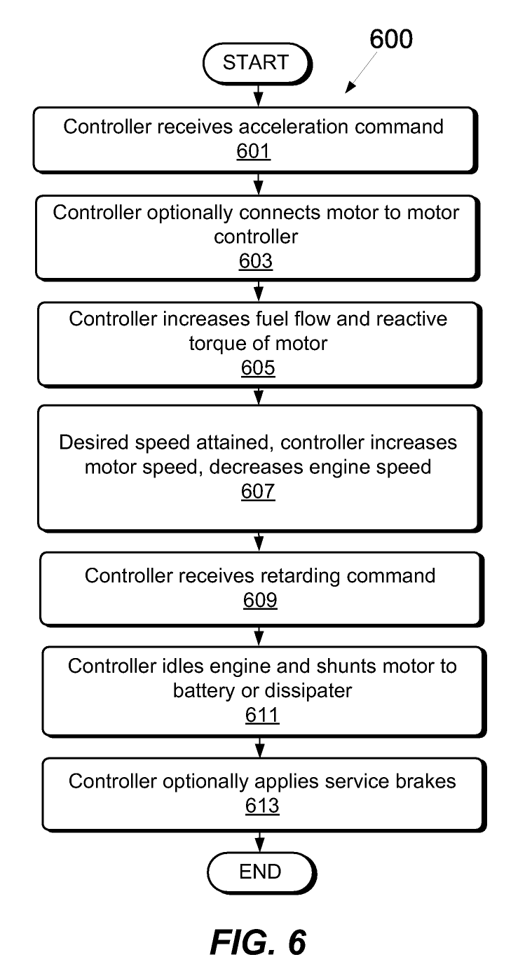

The process executed by the controller 105 in regulating and coordinating the lossless buffer 109, engine 101 and motor 103 is shown via the process 600 of FIG. 6. Although the process 600 proceeds from a stationary state, through a moving state, returning to a stationary state, it will be appreciated that the initial state may be other than stationary and that the control process in such a case would be executed from the appropriate step onward.

The initial state of the host machine prior to execution of process 600 is idle, i.e., the engine 101 is running but the host machine is not moving. At stage 601 of the process 600, the controller 105 receives an acceleration command, e.g., from a physical or electrical user interface element. Pursuant to the command received at stage 601, the controller 105 first optionally connects the motor 103 to a motor controller at stage 603 if the motor 103 had been providing electrical power to a battery or the like during idling. At stage 605, the controller 105 increases fuel flow to the engine 101 to increase its output power, while also increasing the reactive torque provided by the motor 103 via the motor controller. These actions have the net effect of increasing torque at the buffer output 113 to accelerate the host machine.

Once a desired speed is attained, e.g., further acceleration is not requested, the controller 105 may continue to increase the speed of the motor 103 while decreasing the speed of the engine 101 at stage 607. This increases the effective transmission ratio of the split torque transmission 103 to conserve fuel and allow the engine 101 to operate within an optimal operating range.

At stage 609, the controller 105 receives a retarding command, again optionally resulting from interaction of the user with a user interface element. At stage 611, in response to the retarding command, the controller 105 idles the engine 101 and shunts the motor inputs so that the motor now supplies electrical energy to a battery or dissipater. This action tends to reduce the speed of the machine. If need be, the controller 105 may optionally apply the service brakes of the machine at stage 613.

### INDUSTRIAL APPLICABILITY

The present disclosure is applicable to driven machines having transmissions for imparting motion to the machine. In particular, the disclosed principles provide a mechanism for omitting a clutch and torque converter from the machine drive train while maintaining the ability to start and stop the host machine without lugging or stalling the engine 101. This system may be implemented in on-highway or off-highway machines, construction machines, industrial machines, etc. Although many machines that may benefit from the disclosed principles will be machines used at least occasionally for transport of goods, materials, or personnel, it will be appreciated that such transmissions are used in other contexts as well, and the disclosed teachings are likewise broadly applicable.

Using the disclosed principles, a lossless buffer 109 is disposed in the machine drive train system 100 between driving elements, e.g., engine 101 and motor 103, and a transmission. The buffer provides zero, fractional, and overdrive ratios between the engine 101 and the transmission to allow start up from full stop with the engine 101 running and to allow stopping from forward motion without stalling the engine 101. It will be appreciated that this description provides examples of the disclosed system and technique. However, it is contemplated that other implementations of the disclosure may differ in detail from the foregoing examples. Moreover, the references to examples herein are intended to reference the particular example being discussed at that point and are not intended to imply any limitation as to the scope of the disclosure more generally. All language of distinction and disparagement with respect to various features is intended to indicate a lack of preference for those features, but not to exclude such from the scope of the disclosure entirely unless otherwise indicated. Although the motor 103 has been referred to herein as an electric motor, it will be appreciated that the motor 103 may instead be a hydraulic motor or other non-electric motor without departing from the scope of the disclosed principles.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order and from any suitable step unless otherwise indicated herein or otherwise clearly contradicted by context.

We claim:

1. A split-input single motor drive train system for propelling a host machine, the drive train system comprising:
an engine having a rotational engine output;
an electric motor having a rotational motor output;
a lossless buffer directly receiving the rotational engine output and the rotational motor output, and having a rotational buffer output, rotation of which is a predetermined combination of the rotations of the rotational engine output and the rotational motor output, such that the lossless buffer provides a range of transmission ratios between the rotational engine output and the rotational buffer output, wherein the range of transmission ratios includes a zero transmission ratio; and
a transmission having a rotational transmission input linked directly to the rotational buffer output, as well as a rotational transmission output linked to a propulsion means to propel the host machine, such that rotation of the transmission input rotates the transmission output, causing the propulsion means to propel the host machine.

2. The split-input single motor drive train system according to claim 1, wherein the transmission is configured so that rotation of the transmission output by the propulsion means also rotates the transmission input.

3. The split-input single motor drive train system according to claim 1, wherein the lossless buffer comprises at least one planetary gear set linking the rotational engine output, the rotational motor output, and the rotational buffer output.

4. The split-input single motor drive train system according to claim 3, wherein the lossless buffer further comprises a sun gear, a ring gear, and a planet gear/planet gear carrier assembly linking the sun gear and the ring gear, and wherein the rotational engine output is linked to the sun gear, the rotational motor output is linked to the ring gear, and the rotational buffer output is linked to the planet gear/planet gear carrier assembly.

5. The split-input single motor drive train system according to claim 1, further including a controller communicably linked to the engine and the motor for controlling the rotation of the buffer output, wherein the controller provides multiple drive states including an idle state wherein the host machine is stationary, a moving state wherein the host machine is propelled, and a braking state wherein motion of the host machine is retarded.

6. The split-input single motor drive train system according to claim 5, wherein the controller is configured to electrically link the motor to an electrical storage facility during the braking mode.

7. The split-input single motor drive train system according to claim 5, wherein the controller is configured to electrically link the motor to a resistive dissipation grid during the braking mode.

8. The split-input single motor drive train system according to claim 5, wherein the controller is configured to cause the motor to provide a reactive torque to accelerate the host machine.

9. The split-input single motor drive train system according to claim 5, wherein the controller is configured to adjust the motor operation and engine operation while providing a constant host machine speed to optimize fuel efficiency of the engine.

10. The split-input single motor drive train system according to claim 5, wherein the controller is configured to apply service brakes of the host machine during the braking mode.

11. The split-input single motor drive train system according to claim 1, wherein the propulsion means comprises at least one of tracks and wheels.

12. A machine for providing clutchless engagement of a transmission without the use of a torque converter, the machine comprising:
an engine for propelling the machine, the engine having an engine output;
a transmission linked to a propulsion system for causing the machine to move, the transmission having a transmission input and a transmission output; and
a lossless buffer between the engine and the transmission, wherein the lossless buffer employs a single electric motor to provide ratios in a range including zero between the engine output and the transmission input.

13. The machine according to claim 12, wherein the lossless buffer further includes a planetary gear system linking the engine output, a motor output of the electric motor, and the transmission input.

14. The machine according to claim 13, wherein the planetary gear system includes a sun gear, a ring gear, and a planet gear/planet gear carrier assembly linking the sun gear and the ring gear, and wherein the engine output is linked to the sun gear, the electric motor output is linked to the ring gear, and the transmission input is linked to the planet gear/planet gear carrier assembly.

15. The machine according to claim 13, further including a controller communicably linked to the engine and the electric motor, wherein the controller provides multiple drive states including an idle state wherein the host machine is stationary, a moving state wherein the host machine is propelled, and a braking state wherein motion of the host machine is retarded.

16. The machine according to claim 13, wherein the controller is configured to electrically link the electric motor to an electric al storage facility during the braking mode.

17. The machine according to claim 13, wherein the controller is configured to cause the electric motor to provide a reactive torque to accelerate the host machine.

18. A buffer system for managing a transmission of power between an engine and a transmission in the absence of a torque converter or clutch between the engine and the transmission, the buffer system comprising:
a mechanical buffer receiving as input an output of the engine and providing as output an input to the transmission;
a single electric motor controlling the input-to-output transmission ratio of the mechanical buffer to allow the mechanical buffer to provide such ratios in a range including zero; and
a controller for controlling the single electric motor.

19. The buffer system according to claim 18, wherein the mechanical buffer includes a planetary gear system linking the engine, the single electric motor, and the transmission input, wherein the planetary gear system includes a sun gear, a ring gear, and a planet gear/planet gear carrier assembly linking the sun gear and the ring gear, and wherein the engine is linked to the sun gear, the single electric motor output is linked to the ring gear, and the transmission input is linked to the planet gear/planet gear carrier assembly.

20. The buffer system according to claim 18, wherein the controller is configured to cause the single electric motor to provide a reactive torque to accelerate the transmission input.
